(19) United States
(12) Patent Application Publication
(10) Pub. No.: US 2022/0231288 A1
(43) Pub. Date: Jul. 21, 2022

(54) NONAQUEOUS ELECTROLYTE SECONDARY BATTERY NEGATIVE ELECTRODE AND NONAQUEOUS ELECTROLYTE SECONDARY BATTERY COMPRISING THE SAME

(71) Applicant: HONDA MOTOR CO., LTD., Tokyo (JP)

(72) Inventors: Kiyoshi TANAAMI, Saitama (JP); Toshimitsu TANAKA, Saitama (JP); Yuji ISOGAI, Saitama (JP); Shintaro AOYAGI, Saitama (JP); Takuya TANIUCHI, Saitama (JP); Toshiyuki ARIGA, Saitama (JP)

(21) Appl. No.: 17/578,467

(22) Filed: Jan. 19, 2022

(30) Foreign Application Priority Data
Jan. 19, 2021 (JP) 2021-006218

(51) Int. Cl. H01M 4/38; H01M 4/66; H01M 4/80

(52) U.S. Cl. CPC H01M 4/386; H01M 2004/021; H01M 4/808; H01M 4/661

(57) ABSTRACT

To provide a nonaqueous electrolyte secondary battery negative electrode which enables suppressing durability deterioration, improving cycle durability and energy density, and suppressing the rupture of the conductive paths of a current collector comprising a porous metal body in a region which is the boundary between a coated region with an electrode mixture and an uncoated region (electrode mixture boundary region) and a nonaqueous electrolyte secondary battery comprising the same. A nonaqueous electrolyte secondary battery negative electrode, comprising: a current collecting foil; a pair of current collectors disposed in contact with both surfaces of the current collecting foil and comprising a porous metal body; and a negative electrode material disposed in pores of the porous metal body, wherein the negative electrode material comprises: a negative electrode active material comprising a silicon-based material; a skeleton-forming agent containing a silicate having a siloxane bond; a conductive auxiliary; and a binder.

This application is based on and claims the benefit of priority from Japanese Patent Application No. 2021-006218, filed on 19 Jan. 2021, the content of which is incorporated herein by reference.

### BACKGROUND OF THE INVENTION

### Field of the Invention

The present invention relates to a nonaqueous electrolyte secondary battery negative electrode and a nonaqueous electrolyte secondary battery comprising the same.

### Related Art

In recent years, use of nonaqueous electrolyte secondary batteries, such as lithium ion secondary batteries, for cars and the like is increasing as they are small and light-weight and enables obtaining high power. A nonaqueous electrolyte secondary battery is a battery system using an electrolyte not containing water as the main ingredient for an electrolyte, and is a general term for chargeable and dischargeable power storage devices. For example, lithium ion batteries, lithium polymer batteries, lithium all-solid batteries, lithium-air batteries, lithium sulfur batteries, sodium-ion batteries, potassium-ion batteries, multivalent ion batteries, fluoride batteries, sodium sulfur batteries, and the like are known. This nonaqueous electrolyte secondary battery mainly comprises a positive electrode, a negative electrode, and an electrolyte. When the electrolyte has fluidity, the nonaqueous electrolyte secondary battery is configured by further placing a separator between the positive electrode and the negative electrode.

For example, a technique for making a skeleton-forming agent containing a silicate having siloxane bonds exist at least on the surface of an active material and making the skeleton-forming agent permeate the inside from the surface to improve a battery life is disclosed (for example, refer to Patent Document 1). According to this technique, a firm skeleton can be formed in the active material, and thus it is supposed that the battery life can be improved. A technique in which the skeleton-forming agent is applied to a negative electrode containing a silicon (Si)-based active material is also disclosed (for example, refer to Patent Document 2).
Patent Document 1: Japanese Patent No. 6369818
Patent Document 2: Japanese Patent No. 6149147

### SUMMARY OF THE INVENTION

Improvement in energy density is required for the nonaqueous electrolyte secondary battery. It is considered that an increase in the film thickness of a negative electrode or the densification of a negative electrode active material is effective for improvement in energy density. However, in conventional technology, the thickness of a negative electrode has a limit when the negative electrode is manufactured. A practical thickness of a film obtained by applying an electrode mixture layer to a conventional current collecting foil is specifically less than 100 μm. In the case of a film thickness of 100 μm or more, problems such as uneven coating, cracks, and exfoliation occur, and it is difficult to manufacture a high-precision negative electrode.

There is a limit to the amount of a negative electrode active material per unit area from the viewpoint of durability due to the balance between the binding capacity of a binder and the expansion and contraction of a negative electrode active material. The limit to the active material capacity of a negative electrode per unit area is specifically around 4 mAh/cm² (film thickness: 50 μm). If the active material capacity is around 4 mAh/cm² or more, enough cycle performance cannot be maintained. Meanwhile, if the active material capacity is less than 4 mAh/cm², the energy density cannot be expected to be improved.

In order to solve the above problem, it is considered that a porous metal body is applied to the current collector of a negative electrode for a nonaqueous electrolyte secondary battery, and the porous metal body is impregnated with an electrode mixture. However, it has been found that when the current collector of the negative electrode comprises a porous metal body, the difference in expansion and contraction between a coated region, in which the electrode mixture is applied to the current collector, and an uncoated region (tab region), in which the electrode mixture is not applied to the current collector, is great, and the negative electrode ruptures in the region which is the boundary between the coated region and the uncoated region (boundary region) at the time of the charge and discharge of the nonaqueous electrolyte secondary battery.

Therefore, desired is a nonaqueous electrolyte secondary battery negative electrode which enables suppressing durability deterioration, improving cycle durability and energy density, and suppressing the rupture of the conductive paths of a current collector comprising a porous metal body in a region which is the boundary between a coated region with an electrode mixture and an uncoated region (electrode mixture boundary region) and a nonaqueous electrolyte secondary battery comprising the same.

The present invention has been completed in view of the above. An object of the present invention is to provide a nonaqueous electrolyte secondary battery negative electrode which enables suppressing durability deterioration, improving cycle durability and energy density, and suppressing the rupture of the conductive paths of a current collector comprising a porous metal body in a region which is the boundary between a coated region with an electrode mixture and an uncoated region (electrode mixture boundary region) and a nonaqueous electrolyte secondary battery comprising the same.

(1) The present invention provides a nonaqueous electrolyte secondary battery negative electrode, comprising: a current collecting foil; a pair of current collectors disposed in contact with both surfaces of the current collecting foil and comprising a porous metal body; and a negative electrode material disposed in pores of the porous metal body, wherein the negative electrode material comprises: a negative electrode active material comprising a silicon-based material; a skeleton-forming agent containing a silicate having a siloxane bond; a conductive auxiliary; and a binder to achieve the above object.

(2) In the nonaqueous electrolyte secondary battery negative electrode according to (1), at least one of the pair of current collectors may have a region contacting with the current collecting foil and not filled with the negative electrode material or a region having a negative electrode material filling density lower than that of other regions.

(3) In the nonaqueous electrolyte secondary battery negative electrode according to (1) or (2), the region not filled with the negative electrode material or the region having a negative electrode material filling density lower than that of other regions may have a thickness of 50 μm or less.

(4) In the nonaqueous electrolyte secondary battery negative electrode according to any one of (1) to (3), the skeleton-forming agent may contain a silicate represented by the general formula (1) below:

[Chem. 1]

A₂O.nSiO₂ formula (1)

wherein A represents an alkali metal.

(5) In the nonaqueous electrolyte secondary battery negative electrode of any one of (1) to (4), the porous metal body may be a foamed metal body.

(6) The present invention provides a nonaqueous electrolyte secondary battery, comprising the nonaqueous electrolyte secondary battery negative electrode of any one of (1) to (5).

According to the present invention, it is possible to provide a nonaqueous electrolyte secondary battery negative electrode which enables suppressing durability deterioration, improving cycle durability and energy density, and suppressing the rupture of the conductive paths of a current collector comprising a porous metal body in a region which is the boundary between a coated region with an electrode mixture and an uncoated region (electrode mixture boundary region) and a nonaqueous electrolyte secondary battery comprising the same.

### BRIEF DESCRIPTION OF THE DRAWINGS

FIG. 1 is a figure schematically illustrating the configuration of a nonaqueous electrolyte secondary battery negative electrode according to a first embodiment of the present invention;

FIG. 2 is a figure schematically illustrating a configuration in the nonaqueous electrolyte secondary battery negative electrode of the present invention;

FIG. 3 is a sectional view schematically illustrating the configuration of the nonaqueous electrolyte secondary battery negative electrode according to a second embodiment of the present invention; and

FIG. 4 shows the relationship between the number of cycles and the capacity retention of Examples 1 to 3 and Comparative Example 1.

### DETAILED DESCRIPTION OF THE INVENTION

Hereinafter, a first embodiment of the present invention will be described in detail with reference to figures.

### First Embodiment

[Negative Electrode]

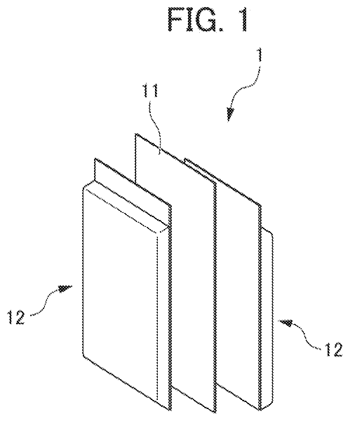

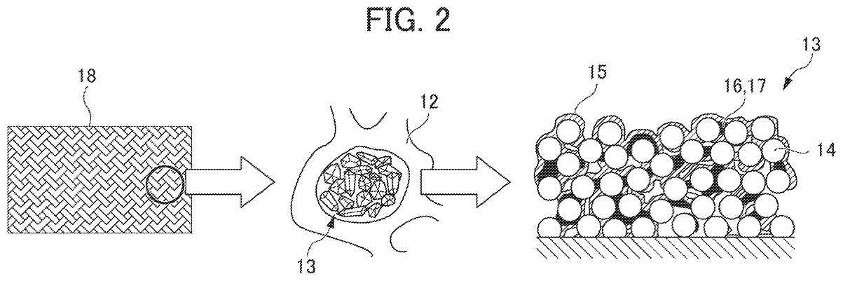

FIG. 1 is a figure schematically illustrating the configuration of a nonaqueous electrolyte secondary battery negative electrode 1 according to a first embodiment of the present invention. The nonaqueous electrolyte secondary battery negative electrode 1 according to the present embodiment has current collecting foil 11 and a pair of current collectors 12 disposed in contact with both surfaces of the current collecting foil and comprising a porous metal body. FIG. 2 is a figure schematically illustrating how a negative electrode material 13 is disposed in a pore of a current collector 12 comprising the porous metal body. The negative electrode material 13 comprises a negative electrode active material 14 comprising a silicon-based material, a skeleton-forming agent 15 containing a silicate having siloxane bonds, a conductive auxiliary 16, and a binder 17. Even though the negative electrode active material 14 filled into the current collector 12 expands or contracts at the time of charge and discharge, the rupture of the conductive paths between the current collecting foil 11 and the current collectors 12 comprising a porous metal body can be suppressed by clamping the current collecting foil 11 with the pair of current collectors 12. Even though the rupture occurs, the electrical continuity (conductive paths) from the current collecting foil side can be secured. For example, a lithium ion secondary battery negative electrode which enables suppress durability deterioration and improving energy density and a lithium ion secondary battery comprising the same can be provided by applying the present embodiment to the lithium ion secondary battery negative electrode. Examples in which the present embodiment is applied to negative electrodes for lithium ion secondary batteries will be described in detail hereinafter. However, within the scope not deviating from the gist of the present invention, various types of addition, modification, or deletion is possible. The pair of current collectors 12 comprising the porous metal body may be called merely a “current collector”. In this case, the “current collector” may refer to both of the pair of current collectors, or may refer to any one of the pair of current collectors.

As the pair of current collectors 12 disposed in contact with both surfaces of the current collecting foil 11, current collectors comprising a porous metal body are used. Meshes, woven fabrics, nonwoven fabrics, embossed bodies, punched bodies, expanded bodies, foamed bodies, and the like are illustrated, and a foamed metal body is preferably used. Especially, the foamed metal body which is a three-dimensional mesh structure having continuous pores is preferably used, for example, CELMET® (manufactured by Sumitomo Electric Industries, Ltd.) or the like can be used. The thicknesses of the pair of current collectors 12 disposed in contact with both surfaces of the current collecting foil 11 and comprising a porous metal body may be the same or different.

As long as the materials of the current collecting foil and the porous metal body are materials which has electron conductivity and in which the retained electrode material can be energized, the materials are not particularly limited, and a conductive metal such as Al, Al alloy, Ni, Ni—Cr alloy, Fe, Cu, Ti, Cr, Au, Mo, W, Ta, Pt, Ru, or Rh; a conductive alloy containing two or more of these conductive metals (stainless steel (SUS304, SUS316, SUS316L, YUS270, or the like)); or the like can be used. When a metal other than the above-mentioned conductive metal or conductive alloy is used, for example, the metal may have a multilayer structure of different type metals in which Fe is covered with Cu or Ni. Especially, Ni or Ni alloy is preferably used due to excellent electron conductivity and reduction resistance. The materials of the current collecting foil and the porous metal body may be the same or different.

The thickness of the current collecting foil is preferably 5 μm or more, and more preferably 8 μm or more. The thickness of the current collecting foil is preferably 20 μm or less, and more preferably 15 μm or less.

The thickness of the porous metal body is preferably 10 μm or more, and more preferably 50 μm or more. The thickness of the porous metal body is preferably 1 mm or less, and more preferably 500 μm or less.

The average pore size of the porous metal body is preferably 500 μm or less. When the average pore size of the porous metal body is in this range, the distance between the negative electrode active material 14 filled into the porous metal body and the metal skeleton

is stabilized, the electron conductivity is improved, and an increase in the internal resistance of the battery is suppressed. Even though the volume changes with charge and discharge, the falling of the electrode mixture can be suppressed.

The specific surface area of the porous metal body is preferably 200 to 10000 m²/m³. This is 2 to 10 times the specific surface area of the conventionally common current collecting foil. When the specific surface area of the porous metal body is in this range, the contact properties between the electrode mixture and the current collector 12 is improved, and an increase in the internal resistance of the battery is suppressed. A more preferable specific surface area is 500 to 7000 m/m³.

The porosity of the porous metal body is preferably 90 to 99%. When the porosity of the porous metal body is in this range, the filling amount of the electrode mixture can be increased, and the energy density of the battery is improved. Specifically, when the porosity exceeds 99%, the mechanical strength of the porous metal body decreases markedly, and the porous metal body is easily damaged due to the volume change of the electrode associated with charge and discharge. Conversely, in the case of less than 90%, not only the filling amount of the electrode mixture, but also the ion conductivity of the electrode decreases and enough input and output characteristics are difficult to obtain. A more preferable porosity is 93 to 98% from these viewpoints.

The electrode coating weight of the porous metal body is preferably 1 to 100 mg/cm². When the electrode coating weight of the porous metal body is in this range, the active material capacity can be fully exhibited, and the capacity as designed can be shown as the electrode. A more preferable electrode coating weight is 5 to 60 mg/cm².

A negative electrode active material 14 which can intercalate and deintercalate lithium ions reversibly is used, and a negative electrode active material 14 comprising a silicon-based material, which has a high capacity, is specifically used. A silicon simple substance, silicon alloy, silicon oxide, silicon compounds, and the like correspond to the silicon-based material. Here, the silicon simple substance refers to crystalline or amorphous silicon with a purity of 95% by mass or more. The silicon alloy means a Si-M alloy comprising silicon and another transition element, M. Examples of M include Al, Mg, La, Ag, Sn, Ti, Y, Cr, Ni, Zr, V, Nb, and Mo. The silicon alloy may be an all solid solution type alloy, a eutectic alloy, a hypoeutectic alloy, a hypereutectic alloy, or a peritectic type alloy. The silicon oxide means an oxide of silicon or a complex comprising the silicon simple substance and SiO₂. The element ratio of 0 to Si may be 1.7 or less:1. The silicon compound is a substance in which silicon and two or more other elements are chemically bound. Since the below-mentioned interface layer can be formed satisfactorily, among these, the silicon simple substance is preferable. Alternatively, a substance in which a carbon-based material is mixed or compounded with a silicon-based material can also be used.

The shape of the silicon-based material is not particularly limited. The silicon-based material may be spherical powder, elliptic powder, hexahedral powder, belt-shaped powder, fibrous powder, flaky powder, doughnut-shaped powder, or hollow powder. These may be single particles or granulated bodies.

The negative electrode active material 14 comprising the silicon-based material has an expansion coefficient of 10% or more due to charge and discharge. That is, although the negative electrode active material 14 expands and contracts greatly at the time of charge and discharge, the durability deterioration due to such expansion and contraction can be suppressed using the below-mentioned skeleton-forming agent 15.

The particle size of the silicon-based material is preferably 0.01 μm to 10 μm from the viewpoints that excellent cycle characteristics of the electrode are achieved and high input and output characteristics are obtained.

The negative electrode active material 14 may contain a carbon-based material (graphite, hard carbon, soft carbon, or the like) besides the above-mentioned silicon-based material.

A skeleton-forming agent 15 containing a silicate having siloxane bonds is used as the skeleton-forming agent 15. More specifically, the skeleton-forming agent 15 preferably contains a silicate represented by the general formula (1) below:

[Chem. 2]

A₂O.nSiO₂ formula (1)

In the above general formula (1), A represents an alkali metal. Especially, preferable A is at least any one of lithium (Li), sodium (Na), and potassium (K). A lithium ion secondary battery which has high strength and excellent heat resistance and cycle life is obtained using such an alkali metal salt of silicic acid having siloxane bonds as the skeleton-forming agent.

In the above general formula (1), n is preferably 1.6 or more and 3.9 or less. When n is in this range, the preparation of skeleton-forming agent liquid by mixing the skeleton-forming agent 15 and water enables obtaining moderate viscosity. As mentioned below, when the skeleton-forming agent liquid is applied to the negative electrode containing silicon as the negative electrode active material 14, the skeleton-forming agent 15 permeates the negative electrode material 13 easily. Therefore, a lithium ion secondary battery which has high strength and excellent heat resistance and cycle life is obtained more certainly. More preferable n is 2.0 or more and 3.5 or less.

The above-mentioned silicate is preferably amorphous. Since an amorphous silicate is in disordered molecular alignment, the amorphous silicate does not break in a specific direction unlike a crystal. Therefore, the cycle life characteristics are improved using the amorphous silicate as the skeleton-forming agent 15.

For example, the skeleton-forming agent 15 permeates between negative electrode active materials 14 by applying the above-mentioned skeleton-forming agent liquid to the negative electrode containing silicon as the negative electrode active material 14. Then, it is presumed that siloxane bonds (—Si—O—Si—) is formed by fusing silicon constituting the negative electrode active material 14 and the above-mentioned silicate constituting skeleton-forming agent 15, and, for example, subjecting a hydrolyzed silicate to dehydration reaction (condensation reaction of silanol groups) by heating. That is, in the lithium ion secondary battery negative electrode 1 of the present embodiment, the interface layer comprising an inorganic substance is formed on the interface between the negative electrode active material 14 and the skeleton-forming agent 15, and silicon derived from siloxane bonds and an alkali metal generated by the hydrolysis of the silicate are contained in this interface layer. It is presumed that the negative electrode active material 14 and the skeleton-forming agent 15 are firmly bound due to the presence of this interface layer, so that the excellent cycle life characteristics are obtained.

In the present embodiment, it is preferable that the ratio of alkali metal atoms to all the constituent atoms in the interface layer is higher than the ratio of alkali metal atoms to all the constituent atoms in the skeleton-forming agent 15. It is more specifically preferable that the ratio of the alkali metal atoms to all the constituent atoms in the interface layer is 5 times or more the ratio of the alkali metal atoms to all the constituent atoms in the skeleton-forming agent 15. Therefore, the bond between the negative electrode active material 14 and the skeleton-forming agent 15 becomes firmer. Peeling, and wrinkles and cracks between the current collecting foil 11 and the current collectors 12 due to the expansion and contraction of the negative electrode active material 14 at the time of charge and discharge are further suppressed, and the conductive paths do not rupture, either. Therefore, the cycle life is further improved.

The thickness of the above-mentioned interface layer is preferably 3 to 30 nm. When the thickness of an interface layer is in this range, the bond between the negative electrode active material 14 and the skeleton-forming agent 15 becomes firmer. Peeling, and wrinkles and cracks between the current collecting foil and the current collectors 12 due to the expansion and contraction of the negative electrode active material 14 at the time of charge and discharge are further suppressed, and the conductive paths do not rupture, either. Therefore, the cycle life is further improved.

The skeleton-forming agent 15 of the present embodiment may contain a surfactant. The lyophilicity of the skeleton-forming agent 15 and the permeability to the negative electrode material 13 are improved, and the skeleton-forming agent 15 permeates the negative electrode material 13 uniformly thereby. Therefore, a uniform skeleton is formed between the negative electrode active materials 14 in the negative electrode material 13, and the cycle life characteristics are further improved.

The content (density) of the skeleton-forming agent 15 based on the negative electrode material 13 is preferably 0.1 to 5.0 mg/cm². If the content of the skeleton-forming agent 15 based on the negative electrode material 13 is in this range, the effect of the use of the above-mentioned skeleton-forming agent 15 is exhibited more certainly.

When the total solid content of the negative electrode active material 14, the skeleton-forming agent 15, the conductive auxiliary 16, and the binder 17 is 100% by mass, the content of the skeleton-forming agent 15 is preferably 3.0 to 40.0% by mass. If the content of the skeleton-forming agent 15 is in this range, the effect of the use of the above-mentioned skeleton-forming agent 15 is exhibited more certainly. When the content of the skeleton-forming agent 15 in the negative electrode material 13 is 3.0% by mass or more, the function of skeleton-forming agent 15 is more fully obtained. When the content of the skeleton-forming agent 15 is 40.0% by mass or less, a decrease in energy density can be further prevented. A more preferable content of the skeleton-forming agent 15 is 5.0 to 30.0% by mass.

Here, in the nonaqueous electrolyte secondary battery negative electrode 1 of the present embodiment, the skeleton-forming agent 15 is disposed at least on the interface with the current collector 12 in the negative electrode material 13. More specifically, the skeleton-forming agent 15 is uniformly disposed not only on the interface between the current collector 12 and the negative electrode material 13 but also in the whole negative electrode material 13, and exists dispersively between the negative electrode active materials 14. Meanwhile, in a conventional nonaqueous electrolyte secondary battery negative electrode, a skeleton-forming agent is unevenly distributed on the surface of the negative electrode material.

The lithium ion secondary battery negative electrode 1 according to the present embodiment contains the conductive auxiliary 16. As long as the conductive auxiliary 16 has electron conductivity, the conductive auxiliary 16 is not particularly limited. A metal, a carbon material, a conductive polymer, conductive glass, or the like can be used. Specific examples include acetylene black (AB), ketjen black (KB), furnace black (FB), thermal black, lamp black, channel black, roller black, disk black, carbon black (CB), carbon fiber (for example, vapor phase growth carbon fiber VGCF®), carbon nanotubes (CNT), carbon nanohorns, graphite, graphene, glassy carbon, and amorphous carbon. One or more of these can be used.

When the total of the negative electrode active material 14, the conductive auxiliary 16, and the binder 17 contained in the negative electrode material 13 is 100% by mass, the content of the conductive auxiliary 16 is preferably 0 to 20.0% by mass. If the content of the conductive auxiliary 16 is in this range, the conductivity can be improved without reducing the negative electrode capacity density, and openings which enables retaining enough liquid of the skeleton-forming agent 15 can be formed in the negative electrode material 13. A more preferable content of the conductive auxiliary 16 is 8.8 to 25.0% by mass.

The conductive auxiliary 16 of the present embodiment preferably have a bulk density of 0.04 to 0.25 mg/cm³. When the bulk density of the conductive auxiliary 16 is in this range, the above-mentioned skeleton-forming agent 15 can be fully impregnated, and the effect of the above-mentioned skeleton-forming agent 15 can be fully exhibited. A more preferable bulk density of the conductive auxiliary 16 is 0.04 to 0.15 mg/cm³.

The lithium ion secondary battery negative electrode 1 according to the present embodiment contains the binder 17. As the binder 17, organic materials such as polyvinylidene fluoride (PVDF), polytetrafluoroethylene (PTFE), polyimide (PI), polyamide, polyamide-imide, aramid, polyacryl, styrene-butadiene rubber (SBR), an ethylene-vinyl acetate copolymer (EVA), a styrene-ethylene-butylene-styrene copolymer (SEBS), carboxymethylcellulose (CMC), xanthan gum, polyvinyl alcohol (PVA), ethylene vinyl alcohol, polyvinyl butyral (PVB), ethylene vinyl alcohol, polyethylene (PE), polypropylene (PP), polyacrylic acid, poly(lithium acrylate), poly (sodium acrylate), poly(potassium acrylate), poly(ammonium acrylate), poly(methyl acrylate), poly(ethyl acrylate), poly(amine acrylate), polyacrylic ester, epoxy resins, polyethylene terephthalate (PET), polybutylene terephthalate (PBT), nylon, vinyl chloride, silicone rubber, nitrile rubber, cyanoacrylate, urea resins, melamine resins, phenol resins, latex, polyurethane, silylated urethane, nitrocellulose, dextrin, polyvinylpyrrolidone, vinyl acetate, polystyrene, chloropropylene, resorcinol resins, polyaromatic, modified silicone, methacryl resins, polybutene, butyl rubber, 2-propenoic acid, cyanoacrylic acid, methyl methacrylate, glycidyl methacrylate, acryl oligomers, 2-hydroxyethyl acrylate, alginic acid, starch, Japanese lacquer, sucrose, glue, casein, and cellulose nanofiber may be used alone or in combination of two or more.

Mixtures of the above-mentioned various organic binders and inorganic binders may be used. Examples of the inorganic binder include silicate-based binders, phosphate-based binders, sol-based binders, and cement-based binders. For example, inorganic materials such as lithium silicate, sodium silicate, potassium silicate, cesium silicate, guanidine silicate, ammonium silicate, silicofluorides, borates, lithium aluminate, sodium aluminate, potassium aluminate, aluminosilicates, lithium aluminate, sodium aluminate, potassium aluminate, poly aluminium chloride, poly aluminum sulfate, poly aluminum sulfate silicate, aluminum sulfate, aluminium nitrate, ammonium alum, lithium alum, sodium alum, potassium alum, chromium alum, iron alum, manganese alum, ammonium nickel sulfate, diatomite, polyzirconoxane, polytantaloxane, mullite, white carbon, silica sol, colloidal silica, fumed silica, alumina sol, colloidal alumina, fumed alumina, zirconia sol, colloidal zirconia, fumed zirconia, magnesia sol, colloidal magnesia, fumed magnesia, calcia sol, colloidal calcia, and fumed calcia, titania sol, colloidal titania, fumed titania, zeolites, silicoaluminophosphate zeolites, sepiolite, montmorillonite, kaolin, saponite, aluminium phosphate, magnesium phosphate, calcium phosphate, iron phosphate, copper phosphate, zinc phosphate, titanium phosphate, manganese phosphate, barium phosphate, tin phosphate, low melting point glass, mortar, gypsum, magnesium cement, litharge cement, Portland cement, blast furnace cement, fly ash cement, silica cement, phosphate cement, concrete, and solid electrolytes may be used alone or in combination of two or more.

Since, in the present embodiment, the negative electrode active material 14 and the skeleton-forming agent 15 are firmly bound by the above-mentioned interface layer formed using the skeleton-forming agent 15, all the above-mentioned binder 17 can be used. When the total of the negative electrode active material 14, the conductive auxiliary 16, and the binder 17 contained in the negative electrode material 13 is 100% by mass, the content of binder 17 is preferably 0.1 to 60% t by mass. When the content of the binder 17 is in this range, the ion conductivity can be improved, high mechanical strength is obtained, and excellent cycle life characteristics are obtained without reducing the negative electrode capacity density. A more preferable content of the binder 17 is 0.5 to 30, by mass.

The thickness of the nonaqueous electrolyte secondary battery negative electrode 1 of the present embodiment comprising the above configuration is preferably 50 μm to 1000 μm. If the thickness of the nonaqueous electrolyte secondary battery negative electrode 1 is in this range, the durability deterioration can be suppressed, and the energy density can be improved as compared with conventional negative electrodes. A more preferable thickness of the nonaqueous electrolyte secondary battery negative electrode 1 is 150 μm to 800 μm.

In the nonaqueous electrolyte secondary battery negative electrode 1 of the present embodiment, it is preferable that the distance between the current collector 12 comprising the porous metal body and the negative electrode active material 14 is 50 μm or less. If the distance between the current collector 12 comprising the porous metal body and the negative electrode active material 14 is 50 μm or less, the durability deterioration can be suppressed. A more preferable distance between the current collector 12 comprising the porous metal body and the negative electrode active material 14 are 30 μm or less.

[Positive Electrode]

Next, a positive electrode when a lithium ion secondary battery is constituted using the above-mentioned negative electrode will be described. As long as a positive electrode active material is a positive electrode active material usually used in a lithium ion secondary battery, the positive electrode active material is not particularly limited. For example, positive electrode active materials such as alkali metal transition metal oxide-based positive electrode active materials, vanadium-based positive electrode active materials, sulfur-based positive electrode active materials, solid solution-based positive electrode active materials (a lithium-rich type, a sodium-rich type, and a potassium-rich type), carbon-based positive electrode active materials, and organic matter-based positive electrode active materials are used.

The lithium ion secondary battery positive electrode of the present embodiment may contain a skeleton-forming agent in the same way as the above-mentioned negative electrode. The same skeleton-forming agent as in the above-mentioned negative electrode can be used, and a preferable content of the skeleton-forming agent is the same as that of the negative electrode.

The lithium ion secondary battery positive electrode of the present embodiment may contain a conductive auxiliary. As the conductive auxiliary, the above-mentioned various conductive auxiliaries which can be used in the negative electrode are used. A preferable content of the conductive auxiliary is also the same as that of the negative electrode.

The lithium ion secondary battery positive electrode of the present embodiment may contain a binder. As the binder, organic materials such as polyvinylidene fluoride (PVDF), polytetrafluoroethylene (PTFE), hexafluoropropylene, tetrafluoroethylene, polyacryl, and alginic acid may be used alone or in combination of two or more. The binder may be a mixture of these organic binders and an inorganic binder. Examples of the inorganic binder include silicate-based inorganic binders, phosphate-based inorganic binders, sol-based inorganic binders, and cement-based inorganic binders.

As long as a current collector used for positive electrodes is a material which has electron conductivity, and enables energizing the retained positive electrode active material, the current collector is not particularly limited. For example, conductive substances such as C, Ti, Cr, Ni, Cu, Mo, Ru, Rh, Ta, W, Os, Tr, Pt, Au, and Al and an alloy containing two or more of these conductive substances (for example, stainless steel or an Al—Fe alloy) can be used. When a substance other than the above-mentioned conductive substances is used, the substance may be different type metals such as iron covered with Al or a multilayer structure of different type elements such as Al covered with C. As the current collector, C, Ti, Cr, Au, Al, stainless steel, or the like is preferable from the viewpoints that the electric conductivity is high, and the stability in an electrolytic solution is high, and C, Al, stainless steel, or the like is moreover preferable from the viewpoints of oxidation resistance and material cost. The current collector is more preferably Al or Al alloy covered with carbon or stainless steel covered with carbon.

The shape of the current collector used for the positive electrode includes linear shapes, rod shapes, plate shapes, foil shapes, and porous shapes. Since the filling density can be increased, and the skeleton-forming agent permeates an active material layer easily, among these, the shape may be a porous shape. Examples of the porous shapes include meshes, woven fabrics, nonwoven fabrics, embossed bodies, punched bodies, expanded bodies, and foamed bodies. The same porous metal body as that of the negative electrode may be used.

[Separator]

In the lithium ion secondary battery of the present embodiment, a separator usually used for a lithium ion secondary battery can be used. For example, a polyethylene fine porous film, a polypropylene fine porous film, a glass nonwoven fabric, an aramid nonwoven fabric, a polyimide fine porous film, a polyolefin fine porous film, or the like can be used as a separator.

[Electrolyte]

In the lithium ion secondary battery of the present embodiment, an electrolyte usually used in a lithium ion secondary battery can be used. Examples include electrolytic solutions in which electrolytes are dissolved in solvents, gel electrolytes, solid electrolytes, ionic liquids, and molten salts. Here, the electrolytic solution refers to an electrolytic solution with an electrolyte dissolved in a solvent.

The electrolyte as the lithium ion secondary battery needs to contain lithium ions as a carrier which conducts electricity. Therefore, as long as the electrolytic salt is used in lithium ion secondary batteries, the electrolytic salt is not particularly limited, and lithium salts are suitable. As this lithium salt, at least one selected from the group consisting of lithium hexafluorophosphate (LiFF₆), lithium perchlorate (LiiClO₄), lithium tetrafluoroborate (LiBF₄), lithium trifluoromethanesulfonate (LiCF₃SO₄), lithium bis(trifluoromethanesulfonyl)imide (LiN(SO₂CF₃)₂), lithium bis(pentafluoroethanesulfonyl)imide (LiN(SO₂C₂F₅)₂), lithium bis(oxalato)borate (LiBC₄O₈), and the like can be used, or two or more thereof can be used in combination.

As long as the solvent for the electrolyte is used in a lithium ion secondary battery, the solvent is not limited. For example, at least one selected from the group consisting of propylene carbonate (PC), ethylene carbonate (EC), dimethyl carbonate (DMC), diethyl carbonate (DEC), ethyl methyl carbonate (EMC), γ-butyrolactone (GBL), methyl-γ-butyrolactone, dimethoxymethane (DMM), dimethoxyethane (DME), vinylene carbonate (VC), vinyl ethylene carbonate (EVC), fluoroethylene carbonate (FEC), and ethylene sulfite (ES) can be used, or two or more thereof can be used in combination.

Although the concentration of the electrolytic solution (concentration of the salt in the solvent) is not particularly limited, the concentration is preferably 0.1 to 3.0 mol/L, and further preferably 0.8 to 2.0 mol/L.

The ionic liquids and the molten salts are classified into pyridine-based, alicyclic amine-based, and aliphatic amine-based ionic liquids and the molten salts by the type of the cation (positive ion). Various ionic liquids or molten salts can be synthesized by selecting the types of anions (negative ions) combined with these. Examples of the cation include ammonium-based cations such as imidazolium salts and pyridinium salts; phosphonium-based ions; and inorganic ions. Examples of the anion to be adopted include halogen-based anions such as a bromide ion and a triflate; boron-based anions such as tetraphenylborate; and phosphorus-based anions such as hexafluorophosphate.

Ionic liquids and molten salts can be obtained, for example, by well-known synthesis methods in which ionic liquids and molten salts are constituted in combination of cations such as imidazolinium and anions such as Br⁻, Cl⁻, BF⁴⁻, PF⁶⁻ (CF₃SO₂)₂N−, CF₃SO³⁻, and FeCl⁴⁻. Even though electrolytes are not added to the ionic liquids and the molten salts, the ionic liquids and the molten salts can function as electrolytic solutions.

The solid electrolytes are classified into sulfide-based, oxide-based, hydride-based, and organic polymer-based solid electrolytes. Many of these are amorphous substances and crystalline substances comprising salts which function as carriers and inorganic derivatives. Since flammable aprotic organic solvents do not need to be used unlike the electrolytic solutions, the gas or the liquid is less likely to be ignited and the liquid is less likely to leak. The battery is expected to be a secondary battery with excellent safety.

[Manufacturing Method]

Next, a method for manufacturing a lithium ion secondary battery according to the present embodiment will be described. The method for manufacturing a lithium ion secondary battery negative electrode according to the present embodiment has a first step of forming negative electrode layer precursors by applying a negative electrode material containing a negative electrode active material, a conductive auxiliary, and a binder to current collectors comprising a porous metal body and drying the negative electrode material. For example, while a nickel porous material having a thickness of 1000 μm is manufactured to provide the nickel porous body wound in the shape of a roll beforehand, a negative electrode active material, a binder, a conductive auxiliary, and the like, as a negative electrode material, are mixed to prepare pasty slurry. Subsequently, the slurry-like negative electrode material is filled and applied to the nickel porous bodies, dried, and then subjected to pressure control treatment to obtain negative electrode layer precursors.

As mentioned above, the negative electrode layer precursors may remain wet without drying. Examples include a method for integrating the negative electrode active material (precursor) by forming negative electrode material layers in the porous current collectors using chemical plating, sputtering, vapor deposition, gas deposition, dipping, press-fitting, or the like besides the above-mentioned slurry application. However, the slurry application or the dipping is preferable from the viewpoints of the lyophilicity of the skeleton-forming agent and electrode manufacturing cost.

The method for manufacturing a lithium ion secondary battery negative electrode according to the present embodiment has a second step of impregnating a skeleton-forming agent containing a silicate having siloxane bonds or a phosphate having phosphate bonds into the negative electrode layer precursors formed in the first step and drying the mixture to form negative electrode layers. For example, the silicate having siloxane bonds or the phosphate having phosphate bonds is purified by a dry method or wet method, and water is added to this for adjustment to prepare skeleton-forming agent liquid containing a skeleton-forming agent. A surfactant may be mixed at this time. As a technique by the dry method, for example, an alkali metal silicate can be produced by adding SiO₂ to water dissolving an alkali metal hydroxide and treating the mixture at 150° C. to 250° C. in an autoclave. As a technique by the wet method, an alkali metal silicate can be produced, for example, by firing a mixture comprising an alkali metal carbonate compound and SiO₂ at 1000° C. to 2000° C. and dissolving this in hot water.

Subsequently, the skeleton-forming agent liquid is applied to the surfaces of the negative electrode layer precursors, and the negative electrode active material is coated. The method for applying a skeleton-forming agent can be performed by a method for dropping and applying a skeleton-forming agent to the surfaces of the precursors of negative electrodes, spray coating, screen printing, the curtain method, spin coating, gravure coating, die coating, or the like besides a method for impregnating the precursors of the negative electrodes into the skeleton-forming agent liquid stored in a tank. The skeleton-forming agent applied to the surfaces of the negative electrode layer precursors permeates the negative electrode, and enters spaces or the like in the negative electrode active material and the conductive auxiliary. The precursors are dried by heat treatment, and the skeleton-forming agent is cured. The skeleton-forming agent forms the skeletons of the negative electrode active material layer thereby.

If the heat treatment temperature is high temperature, the heat treatment time can be shortened, the strength of the skeleton-forming agent is improved, and the above-mentioned heat treatment is therefore performed at preferably 80° C. or more, more preferably 100° C. or more, and desirably 110° C. or more. As long as the current collectors is not molten, the upper limit temperature of the heat treatment is not particularly limited. For example, the temperature may be raised to around 1000° C., which is the melting point of copper. Since binders might be carbonized, or current collectors might be softened in the case of conventional electrodes, the upper limit temperature was estimated to be still lower than 1000° C. Since, in the present embodiment where the skeleton-forming agent is used, the skeleton-forming agent exhibits excellent heat resistance, and is stronger than the current collectors, the upper limit of the temperature is however 1000° C.

The heat treatment can be performed by maintaining the temperature for a heat treatment time of 0.5 to 100 hours. Although an atmosphere for heat treatment may be the air atmosphere, the treatment is preferably performed in a non-oxidative atmosphere to prevent the oxidation of the current collectors.

Moreover, the method for manufacturing a lithium ion secondary battery negative electrode according to the present embodiment has a third step of clamping current collecting foil with a pair of current collectors having the negative electrode layer formed in the above-mentioned first step and second step. A well-known method can be applied to the method for clamping current collecting foil with a pair of current collectors. For example, a method for pressing the laminate while the current collecting foil is sandwiched between the current collectors with a roll press machine can be applied.

Here, in the method for manufacturing a lithium ion secondary battery negative electrode of the present embodiment, B/A, which is the ratio of the density B of the negative electrode layers formed in the second step to the density A of the negative electrode layer precursors formed in the first step is controlled to 0.9<B/A<1.4. B/A, which is the ratio of the density B of the negative electrode layer to the density A of the negative electrode layer precursor (namely, density increase ratio), is specifically controlled to the above-mentioned range by selecting the material type, the amount of the materials, the treatment conditions, and the like. The impregnated skeleton-forming agent spreads in the negative electrode layers thereby, so that the skeleton-forming agent is disposed on the interface with the current collectors in the negative electrode layers. Therefore, high mechanical strength is obtained, and the cycle life characteristics are improved due to skeleton formation by the skeleton-forming agent uniformly disposed in all the negative electrode layers.

In the method for manufacturing a lithium ion secondary battery negative electrode of the present embodiment, the density A of the negative electrode layer precursors formed in the first step is 0.5 to 2.0 g/cm³. B/A, which is the ratio of the density B of the negative electrode layers to the density A of the negative electrode layer precursors (namely density increase ratio), can be adjusted to the above-mentioned range more certainly thereby. The effect of the above-mentioned skeleton-forming agent is enhanced. A more preferable range of density A of the negative electrode layer precursors is 0.6 to 1.5 g/cm³. When the density A of the negative electrode layer precursors is 0.6 g/cm³ or more, a decrease in energy density due to a decrease in electrode density can be suppressed. When the density A is 1.5 g/cm or less, a decrease in capacity can be suppressed.

The method for manufacturing a lithium ion secondary battery positive electrode of the present invention has a step of applying a positive electrode material containing a positive electrode active material, a conductive auxiliary, and a binder to a current collector and drying and rolling the positive electrode material to manufacture a positive electrode. For example, while aluminum foil having a thickness of 10 μm is manufactured to provide the aluminum foil wound in the shape of a roll beforehand, a positive electrode active material, a binder, a conductive auxiliary, and the like, as a positive electrode material, are mixed to prepare pasty slurry. Subsequently, the slurry-like positive electrode material is applied to the surface of aluminum, dried, and then treated in a rolling press step to obtain a positive electrode. A foamed porous body comprising a metal may be used as the current collector. It is characteristic that this current collector is filled with the electrode mixture. Although the method for filling a current collector with an electrode mixture is not particularly limited, examples include a method of filling the slurry containing the electrode mixture into the mesh structure of the current collector by the press-fitting. After the electrode mixture is filled, the filled current collector is dried and then pressed, the density of the electrode mixture can be improved, and the density can be adjusted to a desired density.

Finally, a lithium ion secondary battery can be obtained by cutting the obtained negative electrode and positive electrode to desired sizes, joining the negative electrode and the positive electrode through a separator, and sealing the negative electrode and the positive electrode with the negative electrode and the positive electrode immersed in an electrolytic solution. The structure of the lithium ion secondary battery can be applied to existing battery forms and structures such as laminated batteries and wound batteries.

### Effect

According to the present embodiment, the following effects are produced. In the present embodiment, the nonaqueous electrolyte secondary battery negative electrode 1 having the current collecting foil 11, the pair of current collectors 12 disposed in contact with both surfaces of the current collecting foil and comprising the porous metal body, and the negative electrode material 13 disposed in pores of the porous metal body is configured by incorporating the negative electrode active material 14 comprising a silicon-based material, the skeleton-forming agent 15 containing a silicate having siloxane bonds, the conductive auxiliary 16, and the binder 17 into the negative electrode material 13.

First, when the porous metal body is used as the current collectors 12, the porous metal skeleton enables fixing the negative electrode material 13 in micron size regions and suppressing exfoliation and cracks of the negative electrode. When the current collecting foil 11 is clumped with such current collectors 12, even though exfoliation, cracks, or rupture occurs in the negative electrode due to the expansion and contraction of the negative electrode active material 14, electrical continuity (conductive paths) can be secured with the current collecting foil 11. Therefore, a decrease in battery performance can be suppressed, and the cycle life is improved. When the skeleton-forming agent 15 is used as the negative electrode material 13, the negative electrode material 13 can be fixed in nano size regions. More specifically, the firm binding of the negative electrode active material 14 in the negative electrode material 13 by forming a third layer using the skeleton-forming agent 15 on the interface between the current collector 12 comprising the porous metal body and the negative electrode active material 14 enables suppressing falling at the time of expansion and contraction and enables suppressing durability deterioration. Therefore, although the negative electrode active material 14 comprising a silicon-based material, which has high capacity and very high coefficient of expansion and contraction, is used, electrical continuity (conductive paths) can be secured with the current collecting foil 11 by clamping the current collecting foil 11 using the current collectors 12 with double skeleton structure formed by filling the negative electrode material 13 containing such a skeleton-forming agent 15 into the foamed metal body even in the case of exfoliation, cracks, or rupture in the negative electrode due to the expansion and contraction of the negative electrode active material 14. Since the strength of an electrode mixture boundary region is improved, the negative electrode structure can therefore be maintained even at the time of the full charge and discharge cycle, in which the SOC is 0 to 100. An increase in capacity due to the thickening of the film of the negative electrode, and falling and the rupture of conductive paths at the time of high weight per unit area can be suppressed by extension. High cycle performance can be achieved, and overwhelming high energy density can be achieved.

### Second Embodiment

As another embodiment of the nonaqueous electrolyte secondary battery negative electrode of the present invention, an aspect having a region contacting with the current collecting foil and not filled with a negative electrode material or a region having a low filling density of the negative electrode material as compared with other regions in at least one of a pair of current collectors comprising a porous metal body (hereinafter also called a second embodiment) will also be described in detail with reference to a figure.

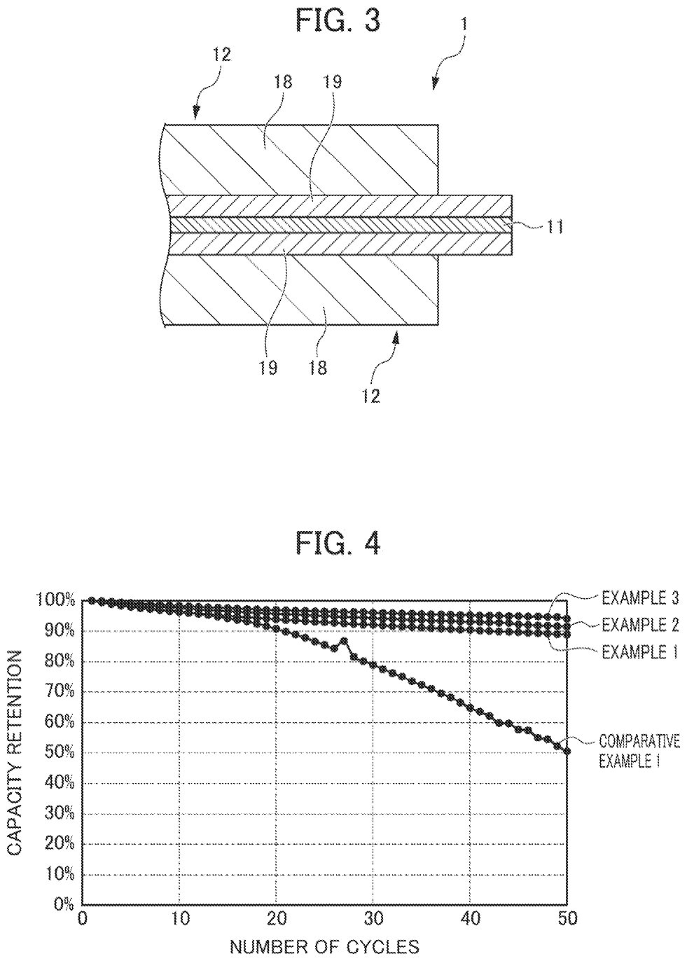

FIG. 3 is a sectional view schematically illustrating the configuration of a nonaqueous electrolyte secondary battery negative electrode 1 according to the present embodiment. The present embodiment has a region 18 having a high filling density of a negative electrode material and a region not filled with the negative electrode material 13 and provided in contact with current collecting foil 11 or a region having a low filling density of the negative electrode material 13 (region 19) in at least one of the current collectors comprising a pair of porous metal bodies. The region not filled with the negative electrode material 13 or the region (19) having a low filling density of the negative electrode material. 13 (region 19) is preferably between the region 18 having a high filling density of the negative electrode material and the current collecting foil 11. Even though the negative electrode active material 14 filled into the pair of current collectors 12 expands or contracts at the time of charge and discharge, the rupture of conductive paths between the current collecting foil 11 and the pair of current collectors 12 comprising the porous metal body can be suppressed by providing such regions in the current collector. Even though rupture occurs, the electrical continuity (conductive paths) from the current collecting foil side is secured. The region not filled with the negative electrode material 13 or the region having a low filling density of the negative electrode material 13 (region 19) refers to a region (thickness) extending to a plane around 50 μm deep from each surface of the pair of the current collectors 12 comprising the porous metal body on the side in contact with the current collector 12 inside each current collector. It is preferable to provide a region extending to the plane around 50 μm deep from the surface of the current collecting foil on the side in contact with each of the pair of current collectors 12 comprising the porous metal body inside each current collector as the region not filled with the negative electrode material 13 or the region having a low filling density of the negative electrode material 13 (region 19).

The region 18 having a high filling density of the negative electrode material in the current collectors 12 comprising the porous metal body has an electrode coating weight of preferably 1 to 100 mg/cm². When the region 18 having a high filling density of the negative electrode material in the current collectors 12 comprising the porous metal body has an electrode coating weight in this range, the active material capacity can be fully exhibited, the capacity as designed can be shown as the electrode. A more preferable electrode coating weight is 5 to 60 mg/cm². The region not filled with negative electrode material 13 or the region having a low filling density of the negative electrode material as compared with other regions in the current collector 12 comprising the porous metal body (region 19) preferably has an electrode coating weight of 0 to 10 mg/cm².

When the region not filled with the negative electrode material 13 or the region having a low filling density as compared with other regions (region 19) in the pair of current collectors 12 comprising the porous metal body has an electrode coating weight in this range, in the nonaqueous electrolyte secondary battery negative electrode, the active material capacity can be fully exhibited, and the capacity as designed can be shown as the electrode. Even though exfoliation, cracks, or rupture occurs in the negative electrode due to the expansion and contraction of the negative electrode active material 14, the electrical continuity (conductive paths) can be more certainly secured with the current collecting foil 11. The region not filled with the negative electrode material 13 or the region having a low filling density of the negative electrode material as compared with other regions (region 19) more preferably has an electrode coating weight of 0 to 5 mg/cm².

“The region having a high filling density of the negative electrode material” and “the region having a low filling density as compared with other regions” mean that, for example, a region having a high coating weight of the negative electrode material and a region having a low coating weight of the negative electrode material exist in the current collector comprising the porous metal body integrally by making the difference in concentration between slurries of the negative electrode material and filling the slurries into the identical current collector or by filling slurries having different concentrations into a plurality of different current collectors and then integrating the current collectors using crimp or the like.

[Manufacturing Method]

Next, a method for manufacturing a lithium ion secondary battery according to the present embodiment will be described. Examples of the method for manufacturing a lithium ion secondary battery according to the present embodiment include two or more. Examples of the manufacturing method include a method A in which a certain surface of each of the current collectors comprising a porous metal body and the surface opposite thereto are filled with negative electrode materials having different concentrations and impregnated with a skeleton-forming agent to form negative electrode layers, and current collecting foil is then clamped with the pair of current collectors to obtain a nonaqueous electrolyte secondary battery negative electrode according to the present embodiment. Hereinafter, the method A will be described in detail.

[Method a for Manufacturing a Nonaqueous Electrolyte Secondary Battery Negative Electrode According to Second Embodiment]

The method A for manufacturing a lithium ion secondary battery negative electrode according to the present embodiment has, for example, a first step of applying a negative electrode material containing a negative electrode active material, a conductive auxiliary, and a binder at different concentrations of the negative electrode material depending on the surface of the current collector to current collectors comprising a porous metal body and drying the negative electrode material to form negative electrode layer precursors having a region having a high filling density of the negative electrode material and a region having a low filling density of the negative electrode material as compared with other regions. For example, while a nickel porous material having a thickness of 1000 μm is manufactured to provide the nickel porous body wound in the shape of a roll beforehand, as a negative electrode material, a negative electrode active material, a binder, a conductive auxiliary, and the like are mixed to prepare pasty slurry. Subsequently, the slurry-like negative electrode material is filled and applied only from a surface of each of the current collector so as not to be filled into all the pores. Moreover, slurry of the negative electrode material obtained by diluting the negative electrode material used at the time of filling and application is applied from the surface opposite to the surface on the side coated with the negative electrode material. Then, negative electrode layer precursors with a region having a high filling density of the negative electrode material and a region having a low filling density of the negative electrode material as compared with other regions can be obtained by drying and pressure control treatment. When the negative electrode material is not filled from the other surface, for example, the surface on the opposite side at this time, negative electrode layer precursors with a region having a high filling density of the negative electrode material and a region not filled with the negative electrode material can be manufactured.

A nonaqueous electrolyte secondary battery negative electrode according to the present embodiment can be manufactured by applying the manufacturing process in the second step and the subsequent step in the first embodiment to a second step and the subsequent step in the manufacturing method A. In the nonaqueous electrolyte secondary battery negative electrode according to the present embodiment, the current collector manufactured using the manufacturing method according to the above-mentioned present embodiment can be used for at least one of the pair of current collectors clamping the current collecting foil. In the present embodiment, the nonaqueous electrolyte secondary battery negative electrode according to the present embodiment and the positive electrode applied in the first embodiment can be applied, and a nonaqueous electrolyte secondary battery comprising the nonaqueous electrolyte secondary battery negative electrode of the present embodiment can be manufactured.

[Method B for Manufacturing a Nonaqueous Electrolyte Secondary Battery Negative Electrode According to Second Embodiment]

Examples of another method for manufacturing a lithium ion secondary battery negative electrode of the present embodiment include a manufacturing method B in which a plurality of current collectors comprising a porous metal body are provided, and the respective current collectors are filled with the negative electrode material at different concentrations to form negative electrode material precursors having different filling densities of the negative electrode material, a skeleton-forming agent is impregnated to form a negative electrode layer, and current collecting foil is then clamped with the plurality of negative electrode layers to obtain a nonaqueous electrolyte secondary battery negative electrode according to the present embodiment. Hereinafter, the manufacturing method B will be described in detail.

The manufacturing method B has a first step of providing the plurality of current collectors comprising the porous metal body, filling the negative electrode material at different concentrations into the respective current collectors, and drying the negative electrode material to form negative electrode layer precursors. Negative electrode layer precursors with a region having a high filling density of the negative electrode material and negative electrode layer precursors with a region having a low filling density of the negative electrode material as compared with other regions can be manufactured by the first step. The method described in the first embodiment can be suitably used for a method for applying the negative electrode material except that the slurries of the negative electrode material at a high concentration and a low concentration and a plurality of the rolls of the current collectors are provided. When the negative electrode material is not applied to the current collectors, the negative electrode layers with regions not filled with the negative electrode material can be manufactured. Current collectors comprising the same porous metal body as the negative electrode layer precursors with regions having a high filling density of the negative electrode material can be suitably used as a material for the negative electrode layer precursors with regions not filled with the negative electrode material or the negative electrode layer precursors with regions having a low filling density the negative electrode material as compared with other regions among the negative electrode layer precursors.

The method B for manufacturing a lithium ion secondary battery negative electrode of the present embodiment has a third step of subsequently applying the second step of the above-mentioned first embodiment to the negative electrode layer precursors obtained in the above-mentioned first step to obtain negative electrode layers, and integrating and forming negative electrode layers corresponding to regions having a high filling density of the negative electrode material; current collectors having regions not filled with the negative electrode material or negative electrode layers with regions having a low filling density of the negative electrode material as compared with other regions; and the current collecting foil. At this time, the negative electrode layers with regions not filled with the negative electrode material and obtained by not applying the negative electrode material are not impregnated with the skeleton-forming agent. The negative electrode layers obtained by not applying the negative electrode material and having regions not filled with the negative electrode material may be subjected to pressure control treatment and the adjustment of the thickness with a roll press machine or the like before the preparation of the nonaqueous electrolyte secondary battery negative electrode. For example, a nonaqueous electrolyte secondary battery negative electrode according to the present embodiment can be obtained by disposing the negative electrode layers corresponding to regions having a high filling density of the negative electrode material outside, the negative electrode material layers corresponding to regions not filled with the negative electrode material or the negative electrode layers corresponding to regions having a low filling density of the negative electrode material as compared with other regions among the current collectors inside, and current collecting foil at the centers and pressing the laminates with a roll press machine or the like while the current collecting foil was sandwiched between the negative electrode layers. In the present embodiment, a nonaqueous electrolyte secondary battery comprising the nonaqueous electrolyte secondary battery negative electrode of the present embodiment can be manufactured by applying the nonaqueous electrolyte secondary battery negative electrode according to the present embodiment and the positive electrode manufactured in the first: embodiment.

The manufacturing method described in the first embodiment can be suitably used for the method for manufacturing a nonaqueous electrolyte secondary battery negative electrode and a nonaqueous electrolyte secondary battery comprising a nonaqueous electrolyte secondary battery negative electrode of the present embodiment, the method for preparing a negative electrode material, and the method for coating current collectors comprising the porous metal body in view of providing regions having a high filling density of the negative electrode material and regions not filled with the negative electrode material and provided in contact with the current collecting foil or regions having a low filling density of the negative electrode material as compared with other regions. As long as there is no adverse effect on the configuration of the second embodiment, the configuration and the method of the first embodiment can be suitably used for parts not described in full detail in the second embodiment.

Here, in the method for manufacturing a lithium ion secondary battery negative electrode of the present embodiment, B/A, which is the ratio of the density of all the negative electrode layers formed in the second step B to the density of all the negative electrode layer precursors formed in the first step A, is controlled to 0.9<B/A<1.4. B/A, which is the ratio of the density of the negative electrode layers B to the density of the negative electrode layer precursors A (namely the density increase ratio) is specifically controlled to the above-mentioned range by selecting the material types, the material amounts, the treatment conditions, and the like. The impregnated skeleton-forming agent spreads into the negative electrode layers thereby, so that the skeleton-forming agent is disposed also on the interface with the current collectors in the negative electrode layers. Therefore, high mechanical strength is obtained, and the cycle life characteristics are improved by skeleton formation by the skeleton-forming agent uniformly disposed in all the negative electrode layers.

In the method for manufacturing a lithium ion secondary battery negative electrode of the present embodiment, the density B of all the negative electrode layers formed in the second step is adjusted to 0.5 to 2.0 g/cm³. B/A, which is the ratio of the density of all the negative electrode layers B to the density of the negative electrode layer precursors A (namely the density increase ratio) can be adjusted to the above-mentioned range more certainly thereby, and the effect of the above-mentioned skeleton-forming agent is enhanced. A more preferable range of the density A of all the negative electrode layer precursors is 0.6 to 1.5 g/cm³. A decrease in energy density due to a decrease in electrode density can be suppressed by adjusting the density A of all the negative electrode layer precursors to 0.6 g/cm³ or more, and a decrease in capacity can be suppressed by adjusting the density A to 1.5 g/cm³ or less.

### Effect

According to the present embodiment, the following effects are produced. In the present embodiment, at least one of the current collectors comprising a pair of porous metal bodies has a region 18 having a high filling density of the negative electrode material and a region not filled with the negative electrode material 13 and provided in contact with the current collecting foil 11 or a region having a low filling density of the negative electrode material 13 (region 19).

In the present embodiment, when at least one of the current collectors comprising a pair of porous metal bodies has a region 18 having a high filling density of the negative electrode material and a region not filled with the negative electrode material 13 and provided in contact with the current collecting foil 11 or a region having a low filling density of the negative electrode material 13 as compared with other regions (region 19), electrical continuity (conductive paths) can be more fully secured with the current collecting foil 11 even in the case of exfoliation, cracks, or rupture in the negative electrode. Therefore, a decrease in performance can be further suppressed, and the cycle life is further improved. Accordingly, although a negative electrode active material 14 comprising a silicon-based material, which has high capacity and a very high coefficient of expansion and contraction, is used, the electrical continuity (conductive paths) can be more fully secured with the current collecting foil 11 by clamping the current collecting foil 11 using such a pair of current collectors 12 even in the case of exfoliation, cracks, and rupture in the negative electrode. Even when the full charge and discharge cycle, in which the SOC is 0 to 100, is performed, the strength of the electrode mixture boundary region is therefore further improved, and the negative electrode structure can therefore be maintained. An increase in capacity due to the thickening of the film of the negative electrode, or falling and the rupture of conductive paths at the time of a high weight per unit area can be further suppressed by extension. Moreover, higher cycle performance can be achieved, and a more overwhelming high energy density can be achieved.

The present invention is not limited to the above-mentioned embodiments. As long as an object of the present invention can be achieved, modification and improvement are included in the present invention. For example, a nonaqueous electrolyte secondary battery is a secondary battery (power storage device) using a nonaqueous electrolyte such as an organic solvent for the electrolyte, and nonaqueous electrolyte secondary batteries include sodium ion secondary batteries, potassium ion secondary batteries, magnesium ion secondary batteries, and calcium ion secondary batteries besides lithium ion secondaries battery. A lithium ion secondary battery means a secondary battery of a nonaqueous electrolyte, which does not contain water as the main ingredient, wherein lithium ions are contained in a carrier, which conducts electricity. For example, lithium ion secondary batteries, metallic lithium batteries, lithium polymer batteries, all-solid lithium batteries, air lithium ion batteries, and the like correspond. Other secondary batteries are also the same. Here, the nonaqueous electrolyte, which does not contain water as the main ingredient, means that the main component in the electrolyte is not water. That is, the nonaqueous electrolyte, which does not contain water as the main ingredient, is a well-known electrolyte used for nonaqueous electrolyte secondary batteries. Even though this electrolyte contains a little water, this electrolyte can function as a secondary battery. However, since water have adverse influence on the cycle characteristics, the storage characteristics, and the input and output characteristics of the secondary battery, it is desirable that this electrolyte be an electrolyte containing water as little as possible. Practically, water in the electrolyte is preferably at 5000 ppm or less.

### EXAMPLES

Next, although the Examples of the present invention will be described, the present invention is not limited to these Examples.

### Example 1

[Manufacturing of Negative Electrodes]

Slurry containing silicon (particle size: 1 to 10 μm) as a negative electrode active material, acetylene black as a conductive auxiliary, polyvinylidene fluoride (PVDF) as a binder was prepared. Subsequently, the prepared slurry was filled into “nickel CELMET”® manufactured by Sumitomo Electric Industries, Ltd. as current collectors so that the coating amount was 5 mg/cm². Then, the coated current collectors were dried and subjected to pressure control treatment to obtain negative electrode layer precursors.

Meanwhile, an aqueous 10% by mass solution of Na₂O.3SiO₂ was prepared as skeleton-forming agent liquid containing a skeleton-forming agent and water. The negative electrode layer precursors obtained above were immersed in the prepared skeleton-forming agent liquid. After the immersion, the precursors of negative electrodes were heated at 160° C. and dried to obtain monolayer negative electrodes in which negative electrode layers were formed.

Next, current collecting foils which were copper foils were disposed at the centers, clamped with the above-mentioned negative electrodes, and the laminates were pressed at a pressure of 1 ton with a roll press machine while the current collecting foils were sandwiched to obtain negative electrodes of the first embodiment.

[Manufacturing of Positive Electrode]

As a positive electrode active material, LiNi_{0.5}Co_{0.2}Mn_{0.3}O₂ (particle size: 5 to 15 μm) was provided. Then, 94% by mass of the positive electrode active material, 4% by mass of carbon black as a conductive auxiliary, and 2% by mass of polyvinylidene fluorides (PVDF) as a binder were mixed. The obtained mixture was dispersed in a suitable amount of N-methyl-2-pyrrolidone (NMP) to produce positive electrode mixture slurry. As current collectors, foamed aluminum having a thickness of 1.0 mm, a porosity of 95%, a cell number of 46 to 50 cells/inch, a pore size of 0.5 mm, and a specific surface area of 5000 m²/m³ was provided. The produced positive electrode mixture slurry was applied to the current collectors by press-fitting so that the coating amount was 45 mg/cm². The coated current collectors were dried in vacuum at 120° C. for 12 hours and roll-pressed at a pressure of 15 ton to manufacture positive electrodes for lithium ion secondary batteries in which the electrode mixture was filled into pores of the foamed aluminum.

[Manufacturing of Lithium Ion Secondary Battery]

As separators, a fine porous film which was a three-layer layered body of polypropylene/polyethylene/polypropylene having a thickness of 15 μm was provided and punched out in a size of 100 mm in length×90 mm in width. The positive electrodes for lithium ion secondary batteries and the negative electrodes for lithium ion secondary batteries obtained above were stacked in order of positive electrode/separator/negative electrode/separator/positive electrode/negative electrode to manufacture an electrode laminated body.

Then, tab leads were joined to the current collecting regions of the electrodes by ultrasonic welding. The electrode laminated body weld-joined to the tab leads was inserted into an aluminum laminate for secondary batteries heat-sealed and processed in the shape of a bag to manufacture a laminate cell. As an electrolytic solution, a solution in which 1.2 mol of LiPF₆ was dissolved in a solvent obtained by mixing ethylene carbonate, dimethyl carbonate, and ethyl methyl carbonate at a volume ratio of 3:4:3 was provided and poured into the above-mentioned laminate cell to manufacture a lithium ion secondary battery.

### Example 2

[Manufacturing of Negative Electrodes]

Slurry containing silicon (particle size: 1 to 10 μm) as a negative electrode active material, acetylene black as a conductive auxiliary, and polyvinylidene fluoride (PVDF) as a binder was provided. Subsequently, the prepared slurry was filled into “nickel CELMET”® manufactured by Sumitomo Electric Industries, Ltd. as current collectors so that the coating amount was 5 mg/cm₂. Then, the coated current collectors were dried and subjected to pressure control treatment to obtain negative electrode layer precursors.

Meanwhile, an aqueous 10% by mass solution of Na₂O₃.3SiO₂ was prepared as skeleton-forming agent liquid containing a skeleton-forming agent and water. The negative electrode layer precursors obtained above were immersed in the prepared skeleton-forming agent liquid. After the immersion, the precursors of negative electrodes were heated and dried at 160° C. to obtain monolayer negative electrodes in which negative electrode layers were formed.

Next, a foamed metal which was nickel having a thickness of 1000 μm and an opening rate of 97% was subjected to pressure control at a pressure of 15 ton with a roll press machine to adjust the thickness to 50 μm.

Next, current collecting foils which were copper foils were installed at the centers, the foamed metal sheets subjected to pressure control were installed inside, and the negative electrodes were installed outside, and the laminates were pressed at a pressure of 1 ton with a roll press machine while the current collecting foils were sandwiched between the foamed metal sheets and the negative electrodes to obtain negative electrodes of the second embodiment.

[Manufacturing of Positive Electrode]

Positive electrodes were manufactured in the same way as in Example 1.

[Manufacturing of Lithium Ion Secondary Battery]

A lithium ion secondary battery was manufactured in the same way as in Example 1.

### Example 3

[Manufacturing of Negative Electrodes]

Slurry containing silicon (particle size: 1 to 10 μm) as a negative electrode active material, acetylene black as a conductive auxiliary, and polyvinylidene fluoride (PVDF) as a binder was prepared. The produced mixture slurry was applied to “nickel CELMET”® manufactured by Sumitomo Electric Industries, Ltd. as current collectors from one side using a plunger type die coater so that the coating amount was 4 mg/cm². Subsequently, the above-mentioned prepared slurry was diluted with N-methyl-2-pyrrolidone (NMP). The diluted slurry was filled into the above-mentioned current collectors from the surface on the side opposite to the surface coated above using a plunger type die coater so that the total of the coating amounts was 5 mg/cm². Then, the coated current collectors were dried and subjected to pressure control treatment to obtain negative electrode layer precursors.

The manufacturing was performed in the same way as in Example 1 subsequently thereto to obtain negative electrodes of a third embodiment.

[Manufacturing of Positive Electrode]

Positive electrodes were manufactured in the same way as in Example 1.

[Manufacturing of Lithium Ion Secondary Battery]

A lithium ion secondary battery was manufactured in the same way as in Example 1.

### Comparative Example 1

[Manufacturing of Negative Electrode]

Slurry containing silicon (particle size: 1 to 10 μm) as a negative electrode active material, acetylene black as a conductive auxiliary, and polyvinylidene fluoride (PVDF) as a binder was prepared. Subsequently, the prepared slurry was filled into “nickel CELMET”® manufactured by Sumitomo Electric Industries, Ltd. as current collectors so that the coating amount was 10 mg/cm². Then, the filled current collectors were dried and subjected to pressure control treatment to obtain negative electrode layer precursors.

Meanwhile, an aqueous 10% by mass solution of Na₂O.3SiO₂ was prepared as skeleton-forming agent liquid containing a skeleton-forming agent and water. The negative electrode layer precursors obtained above were immersed in the prepared skeleton-forming agent liquid. After the immersion, the precursors of negative electrodes were heated and dried at 160° C. to obtain monolayer negative electrodes in which negative electrode layers were formed.

[Manufacturing of Positive Electrode]

Positive electrodes were manufactured in the same way as in Example 1.

[Manufacturing of Lithium Ion Secondary Battery]

A lithium ion secondary battery was manufactured in the same way as in Example 1.

[Durability Test]

A cycle life test was performed on the Examples and Comparative Example. The cycle life test was performed at a test environmental temperature of 25° C., a current density of 0.2 C-rate, and a cutoff potential of 2.5 to 4.2 V.

FIG. 4 shows the relationship between the number of cycles and the discharge capacity of the Examples and Comparative Example. According to Examples 1 to 3, the capacity retention were maintained even in the case of increase in the number of cycles, and therefore it was revealed that a nonaqueous electrolyte secondary battery negative electrode having cycle durability and enables suppressing durability deterioration and improving energy density and a nonaqueous electrolyte secondary battery comprising the same were obtained.

### EXPLANATION OF REFERENCE NUMERALS

1: Nonaqueous electrolyte secondary battery negative electrode
11: Current collecting foil
12: Current collector
13: Negative electrode material
14: Negative electrode active material
15: Skeleton-forming agent
16: Conductive auxiliary
17: Binder
18: Region having high filling density of negative electrode material
19: Region not filled with negative electrode material or region having low filling density of negative electrode material as compared with other regions

What is claimed is:

1. A nonaqueous electrolyte secondary battery negative electrode, comprising:
a current collecting foil;
a pair of current collectors disposed in contact with both surfaces of the current collecting foil and comprising a porous metal body; and
a negative electrode material disposed in pores of the porous metal body,
wherein the negative electrode material comprises: a negative electrode active material comprising a silicon-based material; a skeleton-forming agent containing a silicate having a siloxane bond; a conductive auxiliary; and a binder.

2. The nonaqueous electrolyte secondary battery negative electrode according to claim 1, wherein at least one of the pair of current collectors has a region contacting with the current collecting foil and not filled with the negative electrode material or a region having a negative electrode material filling density lower than that of other regions.

3. The nonaqueous electrolyte secondary battery negative electrode according to claim 1, wherein the region not filled with the negative electrode material or the region having a negative electrode material filling density lower than that of other regions has a thickness of 50 μm or less.

4. The nonaqueous electrolyte secondary battery negative electrode according to claim 1, wherein the skeleton-forming agent contains a silicate represented by the general formula (1) below:
[Chem. 1]
A₂O.nSiO₂ formula (1)
wherein A represents an alkali metal.

5. The nonaqueous electrolyte secondary battery negative electrode according to claim 1, wherein the porous metal body is a foamed metal body.

6. A nonaqueous electrolyte secondary battery, comprising the nonaqueous electrolyte secondary battery negative electrode according to claim 1.
